(19) United States
(12) Patent Application Publication
(10) Pub. No.: US 2002/0165333 A1
(43) Pub. Date: Nov. 7, 2002

(54) Polyisocyanates having alkyl, silyl, siloxane, and carbamate groups and preparing method thereof

(76) Inventors: Jae-Suk Lee, Book-ku (KR); Jun-Hwan Ahn, Book-ku (KR); Yeong-Deuk Shin, Book-ku (KR)

Correspondence Address: FINNEGAN, HENDERSON, FARABOW, GARRETT &, DUNNER LLP, 1300 I STREET, NW, WASHINGTON, DC, 20005, US

(21) Appl. No.: 09/833,677

(22) Filed: Apr. 13, 2001

(30) Foreign Application Priority Data
Feb. 24, 2001 (KR) 01-9495

(51) Int. Cl. C08G 18/00; C08G 18/08; C08G 18/22; C09K 3/00

(52) U.S. Cl. 528/44; 528/57; 252/182.2

(57) ABSTRACT

The present invention relates to polyisocyanates having various functional groups and a preparing method thereof. More particularly, the present invention is to prepare polyisocyantes by living anion polymerization under suitable temperature and pressure enough to protect metal ions to prevent from the formation of trimer of the isocyanate through depolymerization and thus provide polyisocyanates having alkyl, silyl, siloxane and carbamate groups with desirable molecular weight, molecular weight distribution and improved physical properties.

### BACKGROUND OF THE INVENTION

1. Field of the Invention

The present invention relates to polyisocyanates having various functional groups and a preparing method thereof. More particularly, the present invention is to prepare polyisocyantes by living anion polymerization under suitable temperature and pressure enough to protect metal ions to prevent the formation of trimer of the isocyanate formed by depolymerization and thus provide polyisocyanates having alkyl, silyl, siloxane and carbamate groups with desirable molecular weight, molecular weight distribution and improved physical properties.

Conventional polymerization of isocyanates reported is the polymerization of dimethyl formamide (DMF) and sodium cyanide (NaCN) as a solvent and an initiator under N₂ at −58□. However, it has drawbacks in 50-60% of relatively low yield, 34 of molecular weight distribution, and the formation of by-products such as trimer.

Use of an anion initiator is required in the preparation of polyisocyanates for positive charges of C—N bonds due to the carbonyl group of isocyanates and further there is steric hindrance when polyisocyanate chains are formed. The main chain is formed through C—N bonds and thus, a degree of polymerization may be different depending on substituents on nitrogen atom. For example, when any atom or functional group is substituted on the carbon, which is α-position of nitrogen atom, a polymerization may not occur at all. It is required to suppress depolymerization by attacking a carbonyl carbon of an active chain end in the polymerization. If depolymerization occurs, trimers of isocyanates are formed and thus, these trimerizations restrict the formation of living character. Therefore, it is quite difficult to conduct living anion polymerization even at a low temperature.

Another problem of alkylisocyanate polymerization is solubility. Even if DMF has been used widely as a solvent, it has low solubility to monomer and polymer prepared therefrom and thus, it results in low yield and wide range of molecular weight distribution. In order to overcome these problems Okamoto suggested using a mixture of toluene and DMF. Even if a yield is increased, molecular weight distribution is not improved. Tetrahydrofuran (THF) is also used as a solvent to increase solubility but it results rapid formation of trimers. Wang et al. has used SmI₂ in the preparation of polyisocyanates but it also gives low yield of 32-70% and wide molecular weight distribution of 2-4 (J. Wang, R. Nomura, Macromolecules, 1996, 29, 2707: Chemistry Letter, 1996, 10, 909). Novak disclosed use of CpTiCL₂(OR) to obtain isocyanates by living coordination polymerization (T. E. Pattern, B. M. Novak J. of Am. Soc. 1991, 113, 5065: Macromolecules, 1993, 26, 436: Macromolecules, 1996, 29, 5882). However, this living coordination polymerization requires not only a complicate catalyst but also an expensive use thereof and further, yield is not 100% and it cannot be applied for co-polymerization of isocyanates with other monomers.

Endo disclosed use of samarium iodide (II, III) as a ligand for isocyanate polymerization to prevent the formation of trimers. Even if it prevented trimerization, the molecular weight distribution was too broad. Further, 15-crown ether-5 as a δ-ligand is used for triethoxysilylisopropyl isocyanate polymerization to prevent the formation of trimers but it can be applied only to limited monomers.

On the other hand, inventors of the present invention disclosed a preparation method of polyisocyanate having alkoxysilyl groups in Korean Patent Publication No. 2000-38060 but this method can be applied only for preparing the polyisocyanate having alkoxysilyl groups. The monomer isocyanate having alkoxysilyl groups has high solubility in 15-crownether-5 but isocyanate monomer having other functional groups such as hexylisocyanate has relatively lower solubility toward 15-crown ether-5 and thus the formation of trimers cannot be prevented by using 15-crown ether-5 and steric hinderence of 15-crown ether-5 does not affect much to hexylisocyanate due to its relatively smaller conformation than that of isocyanate monomer having alkoxysilyl groups.

### SUMMARY OF THE INVENTION

To free from the aforementioned drawbacks such as difficulty in controlling of molecular weight due to the formation of trimers of polyisocyanates, low yield, wide range of molecular weight distribution, it is an urgent demand to develop novel polyisocyanates with controlled molecular weight and structure.

An object of the present invention is to provide polyisocyanates having various functional groups which can improve physical properties and control molecular weight by polymerizing isocyanates having various function groups, a metal ion as an initiator and a common ion salt which prevent the formation of trimer due to stable metal ion with the end nitrogen ion (N—) of polyisocyanate prepared via anionic polymerization of isocyanate monomer under high vacuum and low temperature.

### BRIEF DESCRIPTION OF THE INVENTION

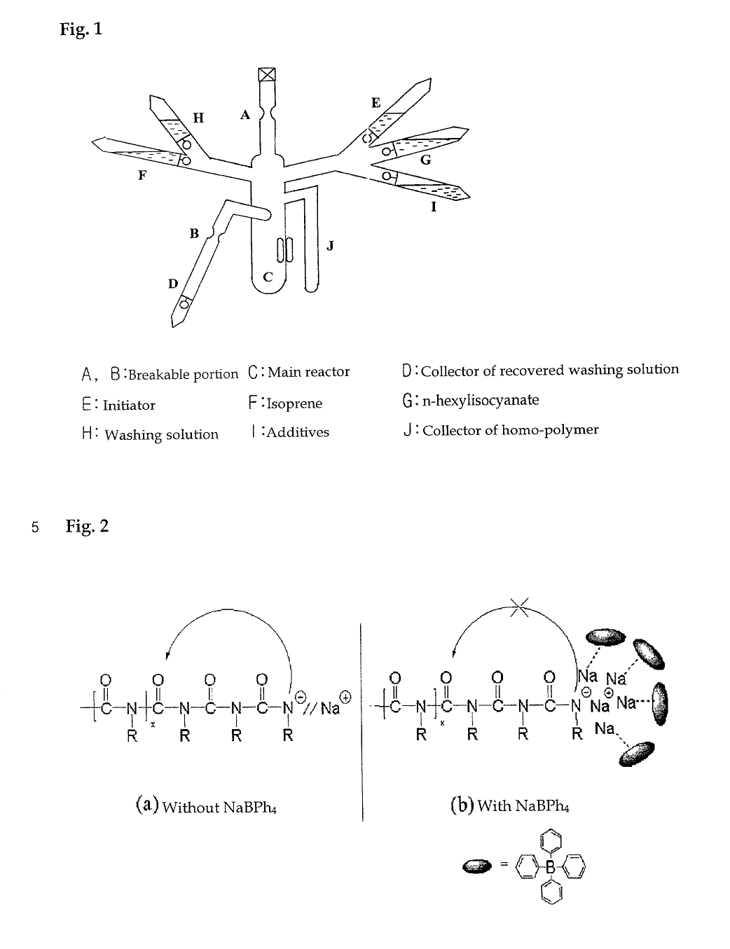

FIG. 1 represents an anion block co-polymerization apparatus to prepare polyisocyanates according to the present invention.

FIG. 2 represents an effect of sodium tetraphenylborate in anion polymerization to prepare polyisocyanates according to the present invention.

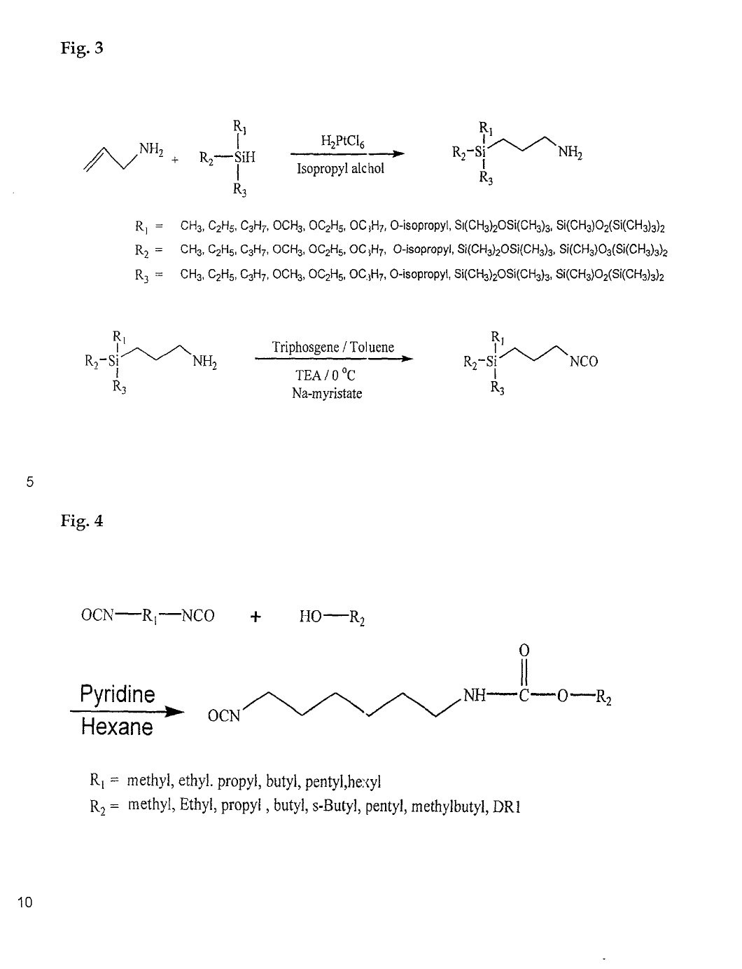

FIG. 3 represents a general p reparation scheme of monoisocyanates having alkyl and silyl groups.

FIG. 4 represents a general preparation scheme of monoisocyanates having carbamate groups.

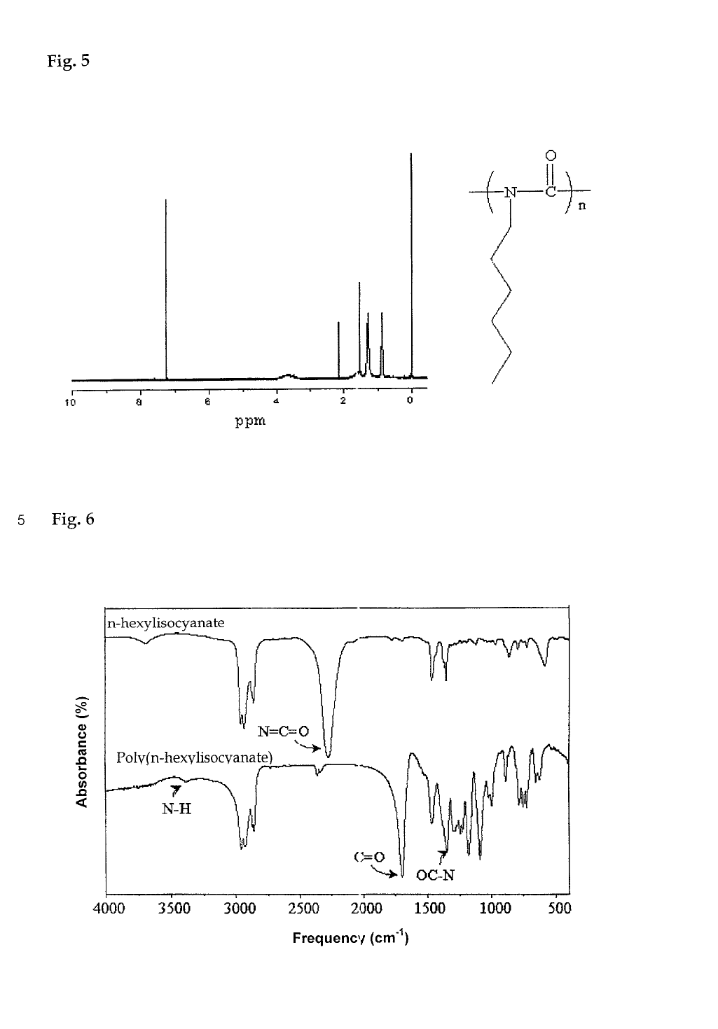

FIG. 5 represents ¹H-NMR spectrum of poly(n-hexyisocyanate) prepared in Example 2.

FIG. 6 represents FT-IR spe(tra of n-hexyisocyanate and poly(n-hexyisocyanate) prepared in Example 2.

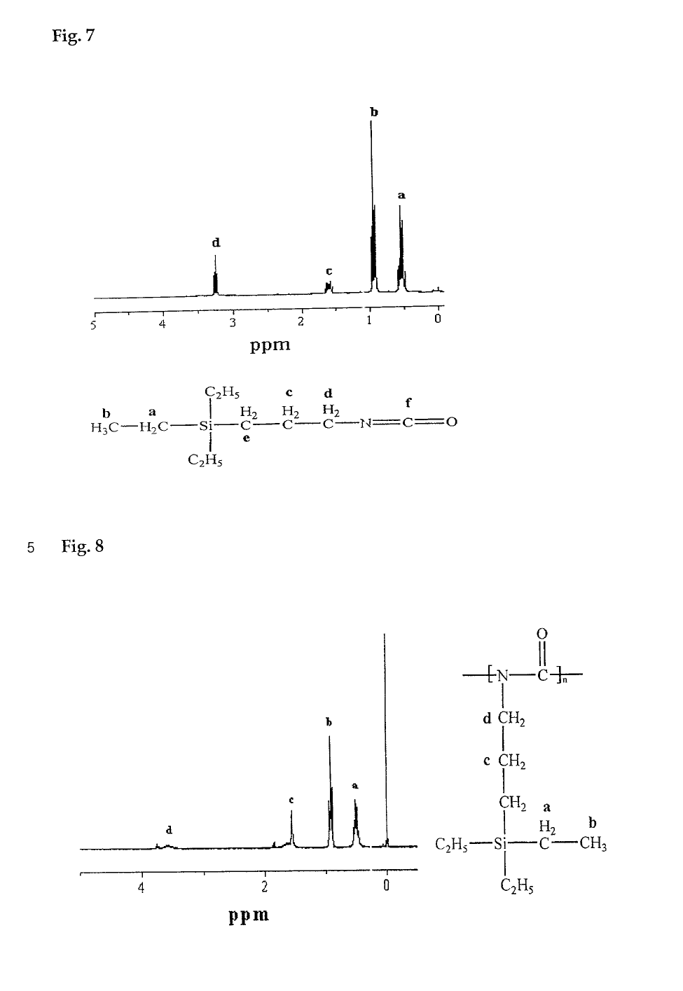

FIG. 7 represents ¹H-NMR spectrum of triethylsilylpropyl isocyanate prepared in Examples 5-8.

FIG. 8 represents ¹H-NMR spectrum of poly(triethylsilylpropyl isocyanate) prepared in Example 8.

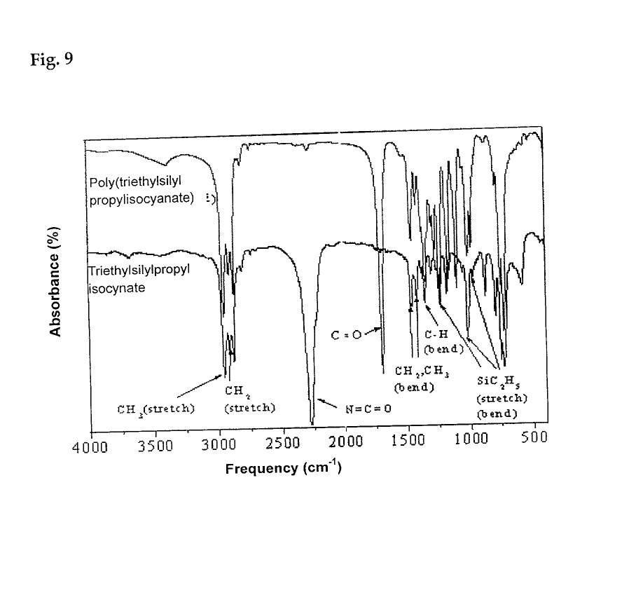

FIG. 9 represents FT-IR spectra of triethylsilylpropyl isocyanate and poly(triethylsilylpropyl isocyanate).

### DETAILED DESCRIPTION OF THE INVENTION

The present invention is characterized by a polymerization of isocyanate monomer, initiator, tetrahydrofuran and common ionic salt under high vacuum and at extremely low temperature for from 5 to 150 minutes to obtain a polyisocyanate having various functional groups, 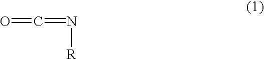 wherein R is —(CH₂)nR₁, —(CH₂)₃SiR₃, —((CH₂)₃SiR₂OSiR₃, —(CH₂)₃SiR₂OSiR₂OSiR₃, —(CH₂)nNHCOOR₄; n is an integer of 1 to 12; R₁, R₂, R₃, R₄=methyl, ethyl, propyl, butyl or pentyl.

The detailed description of the present invention is given hereunder.

Examples of the functional groups of polyisocyante monomers expressed in the formula (1) are alkyl, alkyl silyl, alkoxy silyl, disiloxane, trisiloxane and carbamate.

An initiator of the present invention is preferred to use lithium anion, sodium anion, or potassium anion, more preferably sodium anion.

Common ion salt of the initiator includes tetraphenylbronlithium(tris(1,2-dimethoxyethane), sodium tetraphenylborate, potassium tetrakis(4-chlorophenyl)borate and potassium tetrakis(2-tienyl)borate and it is used to prevent the formation of trimer due to its contact ion pair and steric effects as shown in FIG. 2.

Common ion salt is added 3-12 fold to an initiator to stabilize the end nitrogen ion (N—) of polyisocyanate, prepared via anionic polymerization of isocyanate monomer and metal ion as an initiator under high vacuum and low temperature, with the corresponding anion of the initiator for long period and thus, it prevents the formation of trimer. Therefore, even though a solvent is polar, the nitrogen anion of polyisocyanate can be stabilized by forming contact ion pair and common ion salt can provide steric effect and thus, it prevents the formation of trimer (FIG. 2).

It is preferred to use tetrahydrofuran as a solvent in which isocyanate monomer has high solubility.

The polyisocyanate of the present invention is prepared by anion polymerization of the following Scheme 1.

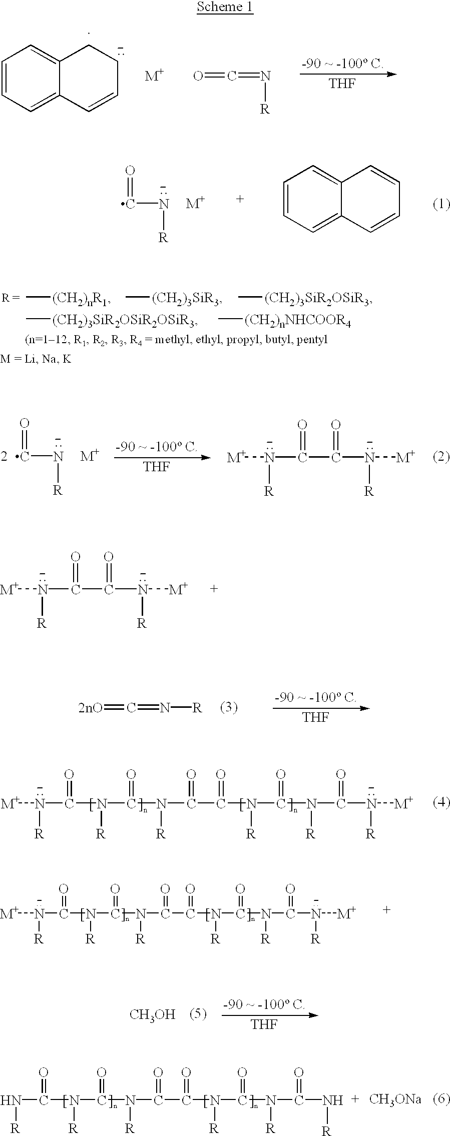

Metal-naphthalenide initiator is used to initiate an isocyanate having alkyl, alkylsilyl, alkoxysilyl, siloxane or carbamate groups in Scheme 1. The initiator contains a radical anion of naphthalene and then the isocyanate is applied to give isocyanate radical anion and naphthalene by attacking of radical anion of naphthalene to O═C═N— of isocyanate as shown an step (1) of Schemel. Then, two isocyanate radical anions react each other as shown in step (2) of Scheme 1 to obtain isocyanate having anions at the ends without radicals.

Then, more of isocyanate monomers are added to the isocyanate having anions prepared in the step (3) of Scheme 1 to grow to a polymer as shown in step (4) of Scheme 1. However, if methanol is added instead of isocyanate monomers [step (5)], the polymerization is terminated as shown in step (6) of Scheme 1.

Optimum condition of the Scheme 1 is 10-6 mmHg of high vacuum, −90 100□ of low temperature and from 5 to 150 minutes of reaction time depending on an amount of isocyanates.

Common ion salt such as sodium tetraphenylborate is added in the step of (1) which is a very beginning step to prevent the formation of trimer of isocyanate by attacking of the anion ends of polyisocyanate to active carbonyl carbon due to contact ion pair and steric effects.

An amount of monomer used for one initiator can be calculated by controlling the amount of monomer to known amount of the initiator of the scheme 1. For example, if an amount of initiator is 0.1 mmol and an amount of monomer is 2 mmol, one initiator requires 40 of monomer and thus, total molecular weight can be determined.

Therefore, the present invention provides homo-polymers of monoisocyanates having functional groups with desired molecular weight and molecular weight distribution by controlling isocyanate monomer of formula 1, post-polymers of said monoisocyanate and monoisocyanate having other functional group and block copolymers with controlled structure prepared by polymerizing said polymer with monomer such as isoprene, styrene, and methylmetacylate.

Of isocyanate monomers of formula 1, a preparing method of monoisocyanate monomer having alkyl or silyl group is shown in FIG. 2. and a preparing method of monoisocyanate monomer having carbamate group is shown in FIG. 4.

As described above, polyisocyanates of the present invention is prepared via anionic polymerization of isocyanates using common ion salt which provides contact ion pair and steric effects to prevent the formation of trimer and thus, molecular weight and molecular weight distribution can be controlled during the polymerization to give polyisocyanate polymers with desired structure.

Hereunder is given a more detailed description of the present invention. However it should not be construed as limiting the scope of the present invention.

### EXAMPLES 1-4

Poly(n-hexylisocyanate) was prepared by the following method using n-hexylisocyante in the following table 1. A reaction condition was from −90 to −100□ of temperature, 10-6 mmHg of pressure and from 10 to 120 minutes of time. The reaction temperature was controlled by freezing methanol with liquid nitrogen and measured with a thermometer for low temperature. An initiator of the reaction was a radical anion compound, green colored sodium-naphthalenide, prepared by reacting sodium and naphthalene in anhydrous THF. The obtained sodium-naphthalenide was immediately stored in a glass ampul under vacuum and diluted into an appropriate concentration. An apparatus for polymerization containing glass ampuls of n-hexylisocyante, the initiator and a protector for depolymerization was connected to vacuum line and kept under high vacuum and N₂. And then the polymerization apparatus was sealed and separated from the vacuum line and rinsed with washing solution and then the reaction was initiated to polymerize by breaking ampul of initiator on methanol thermostat. Further, the ampul of sodium tetraphenylborate as a common ion salt was applied to obtain monomers after the temperature of the reactor and reactants was same. The reaction was terminated by a mixture of hydrogen (chloride and methanol (Examples 1-2) or methanol (Examples 3-4) and the obtained polymers was precipitated out from the excess of methanol and then vacuum-dried (Examples 1-2) or freeze-dried Examples 3-4).

TABLE 1

| | Reactants | | | | | | | | |
|---|---|---|---|---|---|---|---|---|---|
| | Na- | | | Time | Temp. | Mn | Mn | | Yield |
| | Naph¹ | HIC² | NaBPh₄³ | (min) | (□) | calcd.⁴ | obed⁵ | Mw/Mn⁵ | (%) |
| Ex. 1 | 0.10 | 4.89 | 0.97 | 10 | −95 | 11,000 | 12,800 | 1.08 | 89(11)⁶ |
| Ex. 2 | 0.10 | 4.53 | 0.96 | 20 | −98 | 11,500 | 11,700 | 1.09 | 99 |
| Ex. 3 | 0.10 | 4.80 | 0.99 | 30 | −100 | 11,800 | 12,800 | 1.12 | 96 |
| Ex. 4 | 0.09 | 4.97 | 0.90 | 120 | −90 | 11,400 | 10,600 | 1.05 | 81(19)⁷ |

¹⁾initiator (sodium-naphthalenide)
²⁾isocyanate monomer (n-hexyisocyanate)
³⁾common ion salt (sodium tetraphenylborate)
⁴⁾step = (monomer concentration/initiation concentration) × 2 × yield × Mn(127.19) of hexyisocyanate
⁵⁾data was measured by GPC at 35□ and LS
⁶⁾yield of monomers
⁷⁾yield of trimer

Poly(n-hexyisocyanate) of Example 2 was characterized by ¹H-NMR which is shown in FIG. 5. n-Hexyisocyanate and poly(n-hexyisocyanate) which are before and after polymerization were characterized by FT-IR which is shown in FIG. 6. Formation of poly(n-hexyisocyanate) was proved by FIGS. 5 and 6.

### EXAMPLES 5-8

Preparation of Triethylsilylpropyl Isocyanate

Monoisocyanate monomer having silyl group is prepared by the following procedure to confirm that the polymerization method of the present invention can be applied to different isocyanate monomers (FIG. 3). 18g (0.31 mol) of aryl amine and 3 mL of 0.1M H₂PtCl₆x.H₂O (Speier's Catalyst) were placed in 250 mL of 2-neck round-bottomed flask and the reaction mixture was heated at reflux for 1 h under N₂. 25 ml (0.16 mol) of triethyl silane was added to the reaction mixture and reacted further at 90□ for 24 h. After the reaction was completed, it was cooled and excess of aryl amine was removed by vacuum distillation and by-products β-substituted was also removed. A desired γ-substituted product, 3-triethylsilylpropyl amine, was isolated (90%). To the isolated ³-triethylsilylpropyl amine in 250 mL of 2-neck round-bottomed flask were added 16.8 g (0.057 mol) of triphosene, 150 mL of toluene and 18 ml (0.142 mol) of triethyl amine. The reaction mixture was cooled to 0□ with ice-bath and 25 g (0.142 mol) of 3-triethylsilylpropyl amine was slowly added over 30 minutes. The reaction mixture was stirred for 30 minutes and filtered to remove any precipitate. To the filtrate was added sodium myristate and neutralized for 24 h wherein pH was determined by using litmus paper. When it was neutralized, the mixture was filtered and the filtrate was evaporated to dryness and collect the solvent separately. Final product, triethylsilylpropyl isocyanate was obtained by vacuum distillation and characterized by ¹H-NMR (FIG. 7).

### EXAMPLES 9 & 10

Preparation of Poly(Triethylsilyl Isocyanate)

The polymerization of triethylsilylpropyl isocyanate was performed the same as Example 1 except that it was carried under −98 □ of reaction temperature and 10⁻⁶ m Hg of high vacuum in a glass apparatus equipped with break-seals with the function of the time from 10 minutes to 120 minutes and amount of triethylsilylpropyl isocyanate monomer was used 3 fold to the initiator. Molecular weight of the obtained polymer was determined and the result was shown in Table 2.

TABLE 2

| | Reactants(mmol | | | Time | Mn | Mn | | Yield |
|---|---|---|---|---|---|---|---|---|
| | Na-Naph | TEtSPI¹ | NaBPh₄ | (min) | calcd. | obed. | Mw/Mn | (%) |
| Ex. 5 | 0.098 | 3.488 | 0.485 | 10 | 7,740 | 6800 | 1.13 | 62(38)² |
| Ex. 6 | 0.096 | 3.518 | 0.411 | 20 | 12500 | 6800 | 1.13 | 86(13)² |
| Ex. 7 | 0.133 | 3.259 | 0.385 | 30 | 8400 | 8800 | 1.13 | 86(13)² |
| Ex. 8 | 0.135 | 3.409 | 0.325 | 40 | 9800 | 13700 | 1.09 | 97 |
| Ex. 9 | 0.114 | 3.259 | 0.398 | 60 | 11000 | 10300 | 1.16 | 97 |
| Ex. 10 | 0.105 | 3.567 | 0.376 | 120 | 13500 | 12600 | 1.08 | 98 |

¹⁾isocyanate monomer (triethylsilyl isocyanate)
³⁾yield of trimer

Poly(triethylsilyl isocyanate) of Example 8 was characterized by ¹H-NMR which is shown in FIG. 8. Triethylsily isocyanate and poly(triethylsilyl isocyanate) which are before and after polymerization were characterized by FT-IR which is shown in FIG. 9. Formation of poly(triethylsilyl isocyanate) was proved by FIGS. 8 and 9.

### EXAMPLES 11 & 12 AND COMPARATIVE EXAMPLES 1-4

The polymerization of poly(n-hexylisocyanate) was carried out as the function of the time to examine temperature effect on the polymerization and other than that the procedure was the same as Example 3. The vacuum was 10-6 mmHg and the reaction time was 10 minutes. The reaction temperature was 0□ prepared with ice-water bath, −45 □, −93 □, −98□ prepared by passing liquid nitrogen to each 3 mL of acetonitile and methanol in dual flask and −78□ prepared with dry ice and acetone bath. When the solvent was frozen on the bath, frozen solid was cut with glass stick to make it strirred.

TABLE 3

| | Reactants | | | | | | | | |
|---|---|---|---|---|---|---|---|---|---|
| | Na- | | | Time | Temp. | Mn | Mn | | Yield |
| | Naph | HIC | NaBPh₄ | (min) | (□) | calcd. | obed¹ | Mw/Mn¹ | (%) |
| Ex. 1 | 0.10 | 4.92 | 1.0 | 5 | −93 | 12,000 | 42,000 | 1.15 | 95(5)² |
| Ex. 2 | 0.09 | 4.97 | 0.9 | 10 | −98 | 14,000 | 36,500 | 1.21 | 100 |
| Com. | 0.09 | 4.89 | 0.9 | 5 | 0 | — | — | — | 0(100)³ |
| Ex. 1 | | | | | | | | | |
| Com. | 0.110.11 | 4.50 | 1.1 | 5 | −45 | 2,000 | 59,000 | 1.61 | 20(78)³ |
| Ex. 2 | | | | | | | | | |
| Com. | 0.12 | 4.70 | 1.1 | 5 | −78 | 6,000 | 35,000 | 2.31 | 56(42)³ |
| Ex. 3 | | | | | | | | | |
| Com. | | 6.51 | 1.2 | 10 | −78 | 5,500 | 44,000 | 1.82 | 39(59)³ |
| Ex. 4 | | | | | | | | | |

¹⁾data was measured by GPC at 35□ and LS
²⁾yield of monomers
³⁾yield of trimer

As shown in Table 3, the polymerization of polyisocyanates is affected by the reaction temperature. For example, when the reaction temperature was 0□ in Comparative example 1, 100% of trimer was obtained. Therefore, it was confirmed that the yield of desired product increased as the reaction temperature lowered.

### EXAMPLES 13-15 AND COMPARATIVE EXAMPLES 5-6

Polymerization was performed as the function of sodium tetraphenylborate (NaBPh₄) concentration to examine a reactivity of isocyanate with various concentration of NaBPh₄ by the same procedure of Example 1 to obtain polyisocyanate. The reaction was performed under −98□ of reaction temperature, 10⁻⁶ mmHg of high vacuum and 20 minutes of reaction time. The result is shown in Table 4.

TABLE 4

| | Reactants | | | | | | | |
|---|---|---|---|---|---|---|---|---|
| | Na- | | | Time | Mn | Mn | | Yield |
| | Naph | HIC | NaBPh₄ | (min) | calcd. | obed. | Mw/Mn | (%) |
| Ex. 13 | 0.08 | 4.74 | 0.22 | 20 | 14,400 | 23,400 | 122 | 96 |
| Ex. 14 | 0.07 | 4.91 | 0.33 | 20 | 17,100 | 23,600 | 1.17 | 96 |
| Ex. 15 | 0.08 | 4.51 | 0.82 | 20 | 13,900 | 14,500 | 1.06 | 97 |
| Com. Ex. 5 | 0.06 | 5.06 | 0.87 | 20 | 11,800 | 50,200 | 1.10 | 55(45)¹ |
| Com. Ex. 6 | 0.08 | 5.10 | 2.10 | 20 | 6,000 | 20,900 | 1.15 | 36(64)¹ |

¹⁾yield of trimer

As shown in Table 4, living character was controlled with various concentration of NaBPh₄. When NaBPh₄ was used 3-5 fold to the initiator for minutes of reaction time, living character was shown but the living character was retained much shorter than that when it was used 10 fold. When it was used 15 and 25 fold in Comparative Examples 5 and 6, the yields of the desired product were 55 and 36% of low yield and others were monomers not polymerized. Therefore, the effect of sodium tetraphenylborate is important and the concentration thereof can control the living character.

### EXAMPLE 16 AND COMPARATIVE EXAMPLE 7

Block co-polymerization between isoprene and n-hexyisocyanate was performed to examine living character. Isoprene was polymerized for 240 minutes at −78□ of dry ice-acetone bath and further polymerized with sodium tetraphenylborate with 1 equivalent of the initiator at −98□ under 10⁻⁶ mmHg for 20 minutes in a glass apparatus. Molecular weight of the obtained polymer was measured. The result was summarized in Table 5 and increased molecular weight of the block co-polymer was determined by NMR and GPC.

TABLE 5

| | Reactants (mmol) | | | | | | | | |
|---|---|---|---|---|---|---|---|---|---|
| | Na- | | | | Time | Temp. | Mn | Mn | Yield |
| | Naph | isoprene | HIC | NaBPh⁴ | (min) | (□) | calcd. | obed. | (%) |
| Ex. 16 | 0.07 | 1.74 | 4.36 | 1.02 | 240/20 | −78/−98 | 12,800 | 13,500 | 97 |
| Com. | 0.09 | 2.20 | — | — | 240 | −78 | 3,400 | — | 100 |
| Ex. 7 | | | | | | | | | |

### COMPARATIVE EXAMPLES 8-13

Polyisocyanates of n-hexyisocyanates were prepared with the following process the same as in Example 1 except for adding NaBPh4 as a common ion salt. The reaction was performed as the function of the time from 2 minutes to 60 minutes at −98□ under 10⁻⁶ mmHg to investigate a reactivity of n-hexyisocyanate. The reaction was terminated by adding hydrogen chloride acidified methanol (Comparative Examples 8-10) or methanol (Comparative Examples 11-13) and polymers were precipitated into methanol, filtered and dried in vacuo (Comparative Examples 8-10) or freeze-dried (Comparative Examples 11-13).

TABLE 6

| | Reactants | | Time | Mn | Mn | | Yield |
|---|---|---|---|---|---|---|---|
| | Na-Naph | HIC | (min) | calcd. | obed. | Mw/Mn | (%) |
| Com. | 0.11 | 4.43 | 2 | 7500 | 26500 | 1.26 | 74(26)¹ |
| Ex. 8 | | | | | | | |
| Com. | 0.10 | 4.92 | 5 | 12000 | 44400 | 1.14 | 95(5)¹ |
| Ex. 9 | | | | | | | |
| Com. | 0.09 | 4.97 | 10 | 14000 | 36500 | 1.21 | 100 |
| Ex. 10 | | | | | | | |
| Com. | 0.11 | 4.87 | 20 | 10500 | 29600 | 1.26 | 92(8)² |
| Ex. 11 | | | | | | | |
| Com. | 0.09 | 4.71 | 30 | 12000 | 39000 | 1.19 | 89(11)² |
| Ex. 12 | | | | | | | |
| Com. | 0.10 | 4.82 | 60 | 10500 | 72800 | 1.24 | 86(14)² |
| Ex. 13 | | | | | | | |

¹⁾yield of monomers
²⁾yield of trimer

As shown in Table 6, when the reaction time was 10 minutes, the yield of polymer formation was 100% but it was difficult to control the molecular weight distribution (Mw/Mn) and the trimer was formed after 10 minutes of reaction time.

Therefore, use of NaBPh₄ as a common ion salt prevent the formation of trimer and molecular weight is controlled as the function of reaction temperature and the concentration of NaBPh₄.

The polyisocyanates of the present invention were prepared via living anion polymerization of isocyanates to provide improved physical properties such as controlled molecular weight, narrow molecular weight distribution and controlled structure of polymer. Therefore, polyisocyanates are stiff polymers due to amide bond in the polymer main chain and also twisted into helical conformation and thus, it can be applied usefully in optical and liquid crystal materials.

What is claimed is:

1. Polyisocyanates having various functional groups by living anion polymerization of isocyanate monomer expressed by the following formula (1), an initiator, tetrahydrofuran (THF), and common ion salt under high vacuum at extremely low temperature for 5-150 minutes, 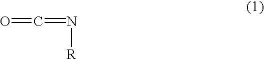
wherein R is —(CH₂)nR₁, —(CH₂)₃SiR₃, —((CH₂)₃SiR₂OSiR₃, —(CH₂)₃SiR₂OSiR₂OSiR₃, —(CH₂)nNHCOOR₄; n is an integer of 1 to 12; R₁, R₂, R₃, R₄=methyl, ethyl, propyl, butyl or pentyl.

2. The polyisocyanates having various functional groups according to claim 1, wherein said high vacuum is 10⁻⁶ mmHg and said low temperature is from −90 to −100□.

3. The polyisocyanates having various functional groups according to claim 1, wherein said initiator is selected from the group consisting of lithium anion, sodium anion and potassium anion.

4. The polyisocyanates having various functional groups according to claim 1, wherein said common ion salt is selected from the group consisting of lithium tetraphenylboron(tris(1,2-dimethoxyethane), sodium tetraphenylborate, potassium tetrakis(4-chlorophenyl)borate and potassium tetradis(2-tienyl)borate.
